(19) United States
(12) Patent Application Publication
(10) Pub. No.: US 2011/0226196 A1
(43) Pub. Date: Sep. 22, 2011

(54) Movimentation System for Engines in General With Use of Compressed Air

(76) Inventor: Jailson Ferreira Leite, Sao Jose dos Campos (BR)

(21) Appl. No.: 13/130,658

(22) PCT Filed: Nov. 19, 2009
(86) PCT No.: PCT/BR2009/000396

§ 371 Date: May 23, 2011

(30) Foreign Application Priority Data
Nov. 24, 2008 (BR) PI 0805028-7

(51) Int. Cl. F02B 41/00

(52) U.S. Cl. 123/22

(57) ABSTRACT

“Movimentation system for engines in general with use of compressed air” envisions a system to convert engines (18) in general for their movimentation using compressed air, which belongs to the pneumatic equipments field, consisting of an adaptation or even a new engine propelled by compressed air, whose technology enables to transform internal combustion engines (18) of cars, motorcycles, boats, vehicles, stationary machines or traction engines on a compressed air powered engine; the movimentation system with compressed air will be managed by a process logical controller or electronic central station(10), in which will be defined the whole trigger, control and shut down logical structure of the entire pneumatic, hydraulic, electrical, automatic and manual system and manual control of the movimentation system for engines with use of compressed air, hydraulic, electrical, mechanical, managed by an electronic central station in the vehicle.

### INVENTION CAMP

The present invention privilege patent belongs to the pneumatic equipments field and treats of mechanical and pneumatic components set, set to perform the movement or drive of an Otto-cycle type motor using compressed air, obtaining forward or rewind rotating movements (displacement) in alternating and/or continuous speeds.

This patent object can be used in machines, vehicles, boats, utilities and development of clean energy generation devices, among other applications that the technique allows.

With the implemented changes is possible to move a car, motorcycle, truck, boat, jet ski or any internal-combustion engine and/or conventional engines, hybrids (fuelling/electric) without using fuel for combustion (gasoline, alcohol, diesel, biodiesel, CNG, ethanol, hydrogen, water and others) and/or converting conventional and electric engines to compressed air engines.

This patent application purpose is to present a pneumatic engine model with low costs for its industrial feasibility, together with robustness requirements, security and practical utility that offers to the costumers, an additional option to congeners market that, against the conventional models, is endowed with many opportunities and benefits, becoming a great expectation and acceptance model to the market sector.

### INVENTION HISTORY

The compressed air powered engine developed by the French engineer Guy Nègre has already been tested with some success, whose technology uses a sequence of larger and smaller pistons in different compression chambers, decompression and single bi-articulated rod that through air expansion and condensation turns it in work that moves the vehicle.

It is an engine that unlike internal combustion engines that use only the Diesel cycle, the air engine also uses the Rankine cycle, in other words, an steam machine ideal cycle, with the reversible processes sequence carried out by steam or condensed and descondensed air, defined by the isentropic compression states, isobaric heating, isentropic expansion and isobaric cooling.

Technical State Deficient Points

The implementation of a change in the internal combustion engine of all automobiles avoids the burning of fossil or non-fossil fuels that are pollutants such as alcohol, gasoline, diesel, biodiesel, CNG, ethanol and others.

Clean fuels, such as hydrogen, are being used with gasoline on the direct burning in internal combustion engine, which make them polluters.

On the other hand, there are vehicles moved by electricity (electric cars) that are moved by electric engines and hybrid cars (electricity and fuels) that are moved by electric and internal combustion engines.

A compressed air car from MDI Company (FlowAir), the pure air engine has 18.5 kw, autonomy of 180 km and maximum speed of 110 km/h with the option of hybrid engine that uses gasoline as a way to extend the autonomy; not in the traditional way, with burning inside the cylinders, but to warm the air. With 36.8 kw it has a 130 km/h speed and autonomy of 50 km only with the compressed air reservoir.

In counterpart it has a 1.500 km range on the road with a consumption corresponding to a motorcycle (50 km/l).

The air refueling takes from one to three minutes at air refueling stations, an advantage over electrical systems that take at least ten minutes to recover part of its load, complete recharges won't take less than four hours.

### INVENTION SUMMARY

The practical necessity of obtaining a propulsion system that can be adapted to existing engines, as well as in new non-polluting engines, since it is moved by compressed air, has taken the inventor with well-known sector knowledge to create and develop this patent object “MOVIMENTATION SYSTEM FOR ENGINES IN GENERAL WITH USE OF COMPRESSED AIR” which envisages an integrated system for pneumatic and other elements that whose technology aims to not pollute the environment.

The non-use of internal combustion into engines avoid the financial expenses and fuel consumption, thereby, get as a good result, not destroy the ozone layer, avoiding the Arctic (North Pole and South Pole) ice melting and thus, future floods in the coastal (sea advance).

There is a better weather control around the world, such as atmospheric air (avoiding the worsening of allergic and respiratory diseases, irritation to eyes and throat, infections resistance reduction, among other problems).

With all the progress achieved by the movimentation system for engines with compressed air and/or hydraulic and with changes into electrical/mechanical system to automate engines, they will become clean energy engines (without polluting the atmosphere).

With this project, it will be possible to make adaptations to existing vehicles in Brazil and perhaps in the entire world, since the air-powered cars from MDI company come manufactured with engines moved by compressed air, with a different way of running the engines and reduced capacity of traveled kilometers, being necessary the refueling in an authorized refueling station and/or the gasoline use to increase the distance to be traveled, which is different from this project because there is no need to refuel the vehicle at any time and neither the fuel use to increase the traveled distance.

The technical advantages are: no need to fuel or refuel the vehicle tanks (reservoirs) with fuel and/or compressed air or recharge the battery in case of hybrid cars and/or electric ones.

The functional advantages are: save the financial cost for several years and thus, also help to preserve the planet and the health of its inhabitants.

Through the use of pneumatic cylinders, hydraulic cylinders or any method to move the moving parts of internal combustion engines without the fuels (gasoline, ethanol, diesel, biodiesel, CNG, ethanol, hydrogen and others) use. With this will be avoided the fuels consumption and help to preserve the weather, the ozone layer and the people health.

### INVENTION DRAWINGS BRIEF DESCRIPTION

The proposed invention privilege patent application characterization is made through representing drawings of the “MOVIMENTATION SYSTEM FOR ENGINES IN GENERAL WITH USE OF COMPRESSED AIR”, so that the product can be fully reproduced by appropriate technique, allowing full functionality characterization of the pleaded object.

From the compiled figures, that express the best or preferred way of making the product now conceived, is based the descriptive part of the report with a detailed and consecutive numbering, where they clarify aspects that may be implied by the adopted representation to clearly determine the requested protection.

These figures are only illustrative and can vary since they do not escape from the originally requested.

Then, to better understanding and comprehension of how is constituted the “MOVIMENTATION SYSTEM FOR ENGINES IN GENERAL WITH USE OF COMPRESSED AIR”, that is pleaded, the attached drawings are presented:

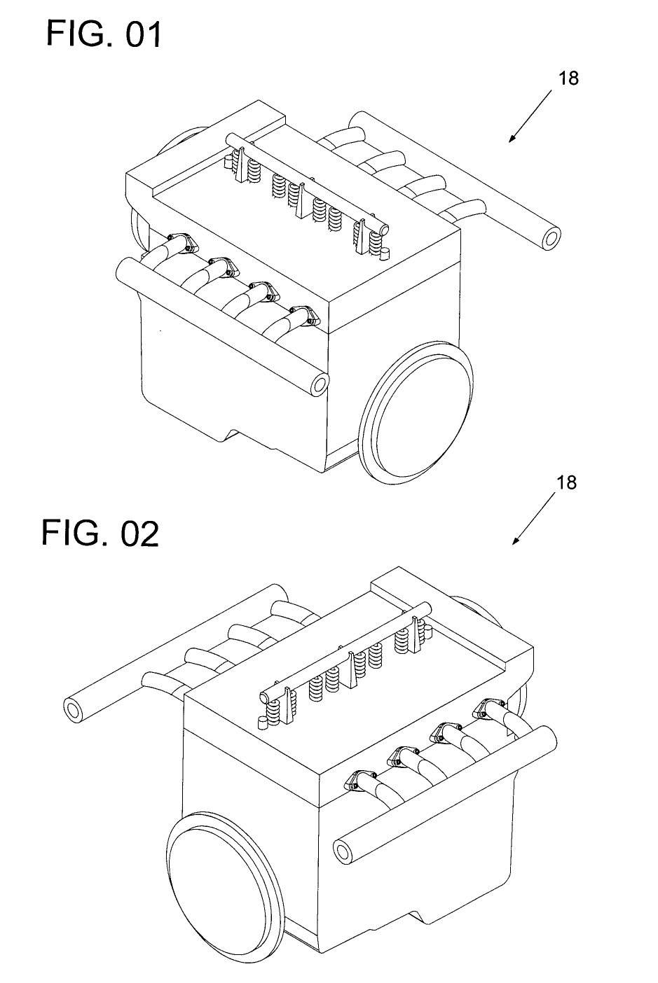

The FIG. 1—Shows a left superior-posterior view of an internal combustion engine converted into an engine with compressed air system propulsion.

The FIG. 2—Shows a right superior-posterior view of an internal combustion engine converted into an engine with compressed air system propulsion.

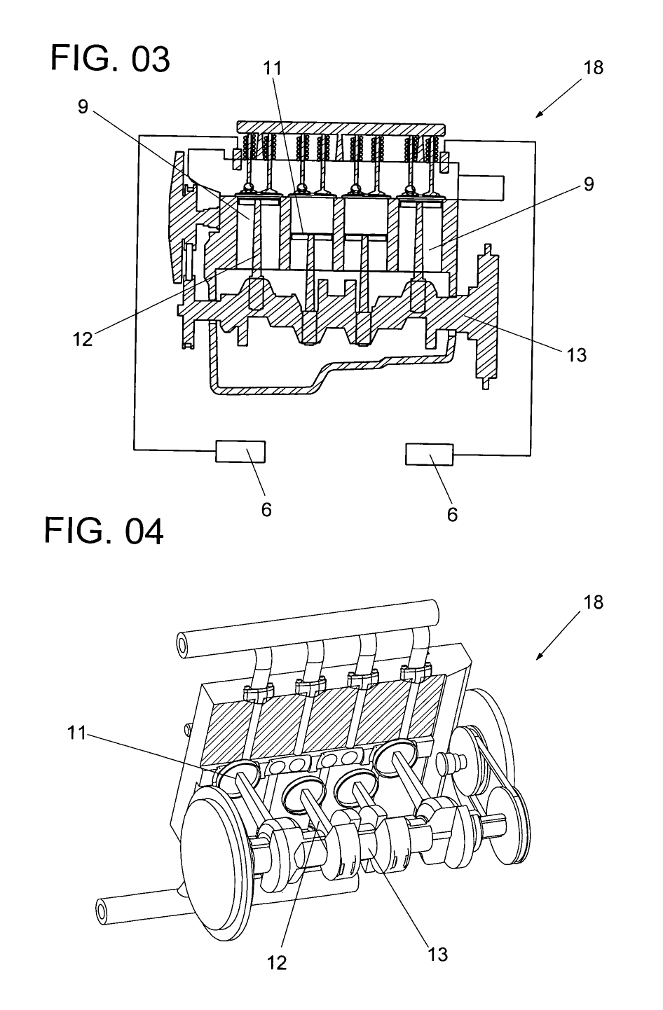

The FIG. 3—Shows a lateral cut-away view of an internal combustion engine converted into an engine with compressed air system propulsion.

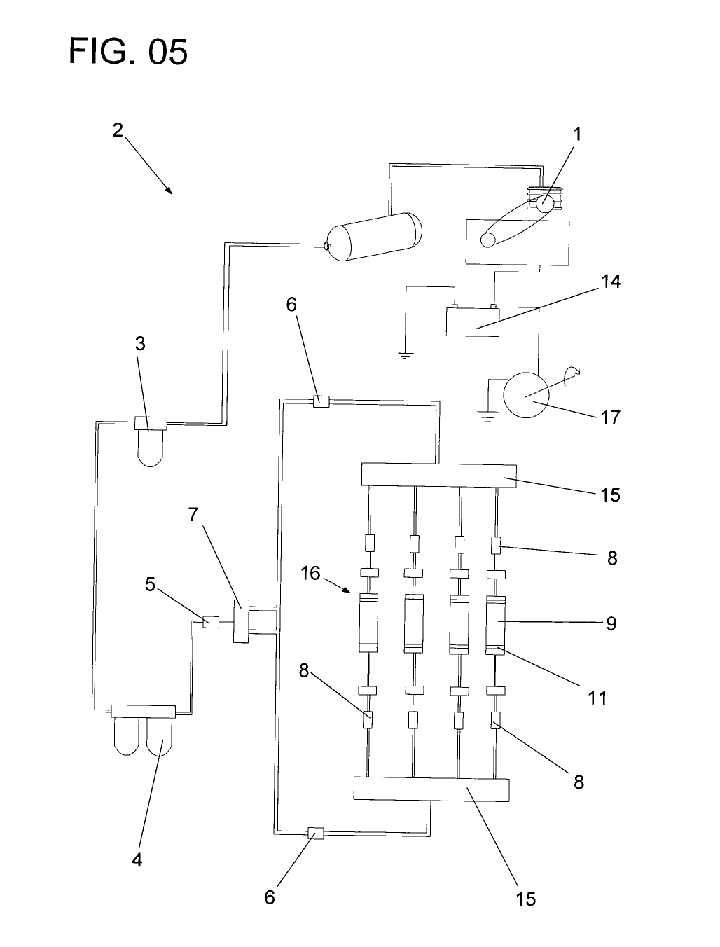

The FIG. 4—Shows a bottom view of the internal components of an internal combustion engine converted into an engine with compressed air system propulsion.

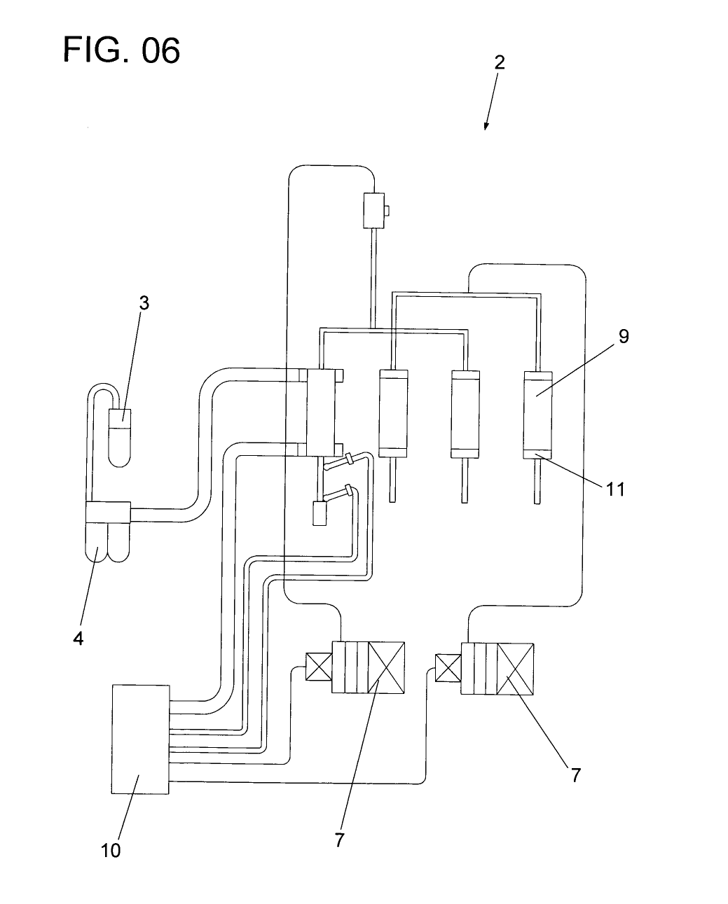

The FIG. 5—Shows a schematic view of the pneumatic system used in an internal combustion engine converted into an engine with compressed air system propulsion.

The FIG. 6—Shows a schematic view of the electrical system associated with the pneumatic system used in an internal combustion engine converted into an engine with compressed air system propulsion.

### INVENTION DETAILED DESCRIPTION

Pursuant to illustrate how the figures listed above, the “MOVIMENTATION SYSTEM FOR ENGINES IN GENERAL WITH USE OF COMPRESSED AIR”, conceives a pneumatic system capable to convert internal combustion engines (18) and others into an air compressed air powered engine self-sufficient.

According to the tests in bench and in field, a modification will be required in vehicles or on the mechanisms and their structures in order to support the work done by pneumatic/hydraulic cylinders and maybe include hydraulic cylinders depending on the required strength to perform the movement in the axis of the crankshaft of internal combustion engines.

Changes are necessary in the proposed systems structures for movimentation (mechanical, pneumatic and hydraulic equipment, software, electronics and electrical) and maybe modify the own solid structure and mechanical structure, of lubrication, of cooling or refrigeration, electrical, automobiles vehicles electronics (internal combustion) and varied adaptations on them (changes in the engine monoblock, camshaft, crankcase, oil pump, filter, oil pipeline transport to the cylinder head, crankshaft bearings, levers to move the pistons, connecting rods, ball joint and rods axis, development of an articulated rod and others), intake valves (air/fuel mixture), escape valve (gases exit from the fuel explosion), head (combustion cameras with their devices where there is the admission, compression and burning of the mixture to cause alternated explosions that move the pistons and the expel the gases from burning), engine block (the engine main structure that hosts the cylinders where the pistons move act as a support for fixing and for the rotation movement of the crankshaft “engine axis” and head fixing), mobile set transforms rectilinear come and go movement of the crankshaft piston in rotation movement, transferring it to the vehicle wheels, making possible the vehicle displacement.

The changes should take place in the fuel actuation structure to compressed air feeding to trigger the pneumatic/hydraulic piston and perhaps add a hydraulic system to trigger hydraulic pistons and changes to the vehicle electrical system to feed the compressor, also feed the vehicle electrical parts recharging the battery, and if necessary, an electricity generator construction to keep the vehicle battery recharged and perhaps modify the engine gas output system “leakage”.

Directing the compressor air output to the leakage and possible changes into the transmission system, clutch, pedal, clutch cable, plateau and disk, gears, balance shaft, used in vehicles with rear-wheel drive or four-wheel drive, differential, in other words, allow the vehicle drive wheels to develop different rotations one from another, when the vehicle moves in curves, semi-axes (connect the wheels differential, transmitting traction).

On vehicles with front-wheel drive, the wheel axis connection with the traction, is achieved by constant velocity joints and possible changes on the steering, suspension system, brake system, and perhaps modify the vehicle structure (composed of rigid and deformable structure) like: monoblock, stringer, body, floors, roof and others, and changes to the vehicle panel (rear panel warning, “visual alarm”).

All these changes should be implemented in order to the vehicles movimentation be made without burning fossil fuels and/or derivatives of them and/or modified (gasoline, alcohol, diesel, biodiesel, natural gas “CNG”, ethanol and others).

Process:

Engage into automobile vehicles an air compressor (1) with appropriate capacity to feed the pneumatic system (2).

The pneumatic system (2) has a clean air filter (3), an air lubrication (4), a compressed air amplifier (5) (pressure multiplier), pressure regulators (6) that acts associated to the triggers frequency, flow control valves (7) (flow controller), electro-valves (8) to control the compressed air flow trigger, pneumatic cylinders (9) for harsh environments (with electromagnetic sensors), mini hydraulic station to 25,000 kPa and hydraulic cylinders to help the motive power generation.

Fix:

Pneumatic cylinders (9) and/or hydraulic cylinders and control electronic stations (10) (PLC) of the pneumatic/hydraulic system and other items that compose the pneumatic/hydraulic/electrical/mechanical movimentation system electrical/internal combustion engines to move the pistons (11) that are connected through the rod (12) to the crankshaft bearing (13) to reach the rectilinear come and go pistons movement that will be turned into rotation movement and transmitted to the wheels, causing the vehicle to move.

Air Compressor Electrical Power (1):

The power will be supplied by the vehicle battery (14), whose voltage is 12 VDC, which will be divided into two distinct voltages, one that will remain on 12 VDC for powering the vehicle electronic circuitry and the other will be converted by an appropriated circuit, for a 110 VAC voltage to power the air compressor (1), also the alternator or electricity generator (17) will continue performing the vehicle battery recharging (14) and, if necessary, another electricity generator will be implemented to improve the recharging battery system.

The Electronic Station (10) Will Manage:
The triggering and shutting down of the air compressor (1) and the safety limit temperature to prevent damage.
The electro-valves trigger timer (8).
The air flow control.
The pressure multiplier (15), necessary for higher amount of compressed air in the system, in order to accomplish the pneumatic cylinders (9) movimentation.
Mini hydraulic station control, if necessary.
The hydraulic cylinders triggering for moving the pistons (11) and the crankshaft (13), start and end electromagnetic sensors (16) of hydraulic cylinders stroke.
The air flow control valves (7) (flow controller).
The pneumatic cylinders (9) trigger (the crankshaft pistons movement).
The start and end electromagnetic sensors (16) of pneumatic cylinders stroke (9).
The monitoring of the division, amplification, multiplication, direct and alternate current transformation, alternate current stabilization and, if necessary, the electricity generator (17) monitoring to keep the vehicle battery (14) recharged and, if necessary, develop the electric generator and/or feed the electrical system through the electricity generator.
The electrical panel lights control.
The manual controls to start and shutdown the compressed air powered engines automation system, hydraulic, electrical, and mechanical engines of automotive vehicles and their many functions to correct their performance.

The computer program, in this case, in this project will be used the language “Ladder” for PLC (programmed logic controller) programming or electronic central (10), in which will be set the whole triggering, controlling and shutting down logical structure, the entire pneumatic, hydraulic, electrical, automatic and manual systems to control the movimentation system for engines with compressed air, hydraulic, electrical, mechanical, managed by an electronic station in the vehicle.

This present patent descriptive report treated of a new conception of a new autonomous propulsion system using air that presents, as evidenced by the analysis performed and figures shown, many differences over conventional models existing in the market, as well construction techniques and features completely different from those relevant to the technical state.

For the advantages that it offers, and so, for having truly innovative features that meet all the requirements of novelty and originality in the genre, the present “MOVIMENTATION SYSTEM FOR ENGINES IN GENERAL WITH USE OF COMPRESSED AIR” brings together necessary and sufficient conditions to earn the invention privilege.

1. “MOVIMENTATION SYSTEM FOR ENGINES IN GENERAL WITH USE OF COMPRESSED AIR”, characterized by an adaptation in a Otto-cycle or hybrid engine (18) of internal combustion which is transformed into an engine with compressed air propulsion or by an especially developed to act by compressed air propulsion.

2. “MOVIMENTATION SYSTEM FOR ENGINES IN GENERAL WITH USE OF COMPRESSED AIR”, according to claim 1, characterized by having the following mounting procedures:
a) engage in automotive vehicles an air compressor (1) capable of proper pressure to power the pneumatic system (2);
b) the pneumatic system (2) has a clean air filter (3), an air lubrication unit (4), a compressed air amplifier (5) (pressure multiplier), pressure regulators (6) that acts associated to the frequency of triggers, flow control valves (7) (flow controller), electro-valves (8) to control the compressed air flow trigger, pneumatic cylinders (9) for harsh environments (with electromagnetic sensors), mini hydraulic station up to 25,000 kPa and hydraulic cylinders to help the motive power generation;
c) fix: pneumatic or hydraulic cylinders (9) and electronic stations (10) of (PLC) type to control the pneumatic/hydraulic system and the other items that compose the pneumatic/hydraulic/electrical/mechanical movimentation system for internal combustion/electrical engines to move the pistons (11) that are connected through the rod (12) to the crankshaft bearing (13) to reach the rectilinear pistons movement of come and go that will be transformed into rotation movement that will be transmitted to the vehicle wheels, causing its movement.
c.1) air compressor power supply(1): the power will be supplied by the vehicle battery (14), whose voltage is 12 VDC and will be divided into two distinct voltages, one that will remain in 12 VDC for powering the vehicle electronic circuitry and the other will be converted by an appropriate circuit, for a 110 VAC voltage to power the air compressor (1), as the alternator will continue performing the vehicle battery (14) recharging and, if necessary, will be implemented another electricity generator to strengthen the battery recharging system;
d) The electronic station (10) will manage:
d.1) The triggering and shutting down of the air compressor (1) and the safety limit temperature to prevent damage;
d.2) The electro-valves trigger timer (8);
d.3) The air flow control;
d.4) The pressure multiplier (15), necessary for higher amount of compressed air in the system, in order to accomplish the pneumatic cylinders (9) movimentation;
d.5) Mini hydraulic station control, if necessary;
d.6) The hydraulic cylinders triggering for moving the pistons (11) and the crankshaft (13), start and end electromagnetic sensors (16) of hydraulic cylinders stroke;
d.7) The air flow control valves (7) (flow controller);
d.8) The pneumatic cylinders (9) trigger (the crankshaft pistons movement);
d.9) The start and end electromagnetic sensors (16) of pneumatic cylinders stroke (9);
d.10) The monitoring of the division, amplification, multiplication, direct and alternate current transformation, alternate current stabilization and, if necessary, the electricity generator (17) monitoring to keep the vehicle battery (14) recharged and, if necessary, develop the electric generator and/or feed the electrical system through the electricity generator;
d.11) The electrical panel lights control;
d.12) The manual controls to start and shutdown the compressed air powered engines automation system, hydraulic, electrical, and mechanical engines of automotive vehicles and their many functions to correct their performance.

3. “MOVIMENTATION SYSTEM FOR ENGINES IN GENERAL WITH USE OF COMPRESSED AIR”, according to claim 1, characterized by the computer program used is done in “Ladder” language for programming the PLC (programmable logical controller) or electronic station (10), in which will be set the whole trigger, control and shut down logic structure of the entire pneumatic, hydraulic, electrical, automatic and manual system and manual control of the movimentation system for engines with compressed air, hydraulic, electrical, mechanical managed by an electronic central station in the vehicle.
